(19) United States
(12) Patent Application Publication
(10) Pub. No.: US 2015/0182986 A1
(43) Pub. Date: Jul. 2, 2015

(54) COATING APPARATUS

(71) Applicant: Sumitomo Heavy Industries, Ltd., Tokyo (JP)

(72) Inventor: Akira Kusakari, Kanagaawa (JP)

(21) Appl. No.: 14/581,617

(22) Filed: Dec. 23, 2014

(30) Foreign Application Priority Data
Dec. 26, 2013 (JP) 2013-269515

(51) Int. Cl. B05C 11/10

(52) U.S. Cl. CPC B05C 11/1002

(57) ABSTRACT

Provided is a coating apparatus that intermittently coats a coating liquid a sheet that travels in a predetermined direction. The coating apparatus includes a tank that stores a coating liquid, a discharge unit that discharges the coating liquid, which is supplied from the tank, to the sheet, a valve that is provided between the discharge unit and the tank, a linear motor that opens and closes the valve, an acquisition unit that acquires information on the time from the start of valve closing operation of the valve to the end thereof, a linear motor control unit that drives the linear motor so that the valve is closed at an acquired time, and a measurement unit that measures the pressure within the discharge unit.

### RELATED APPLICATION

Priority is claimed to Japanese Patent Application No. 2013-269515, filed Dec. 26, 2013, the entire content of which is incorporated herein by reference.

### BACKGROUND

1. Technical Field

Certain embodiments of the invention relate to a coating apparatus.

2. Description of Related Art

There are known coating apparatuses that intermittently coat a chemical toward a base material, such as a film or glass to thereby form a coating pattern alternately having a coating region and a non-coating region on the base material. In the related art, a coating apparatus using a linear motor for a drive device that drives the opening and closing of a valve for intermittent application is suggested.

### SUMMARY

According to a certain embodiment of the invention, there is provided a coating apparatus that is a certain aspect of the invention is a coating apparatus that intermittently coats a coating liquid on a base material that travels in a predetermined direction. The coating apparatus includes a coating liquid source that stores coating liquid; a discharge unit that discharges the coating liquid, which is supplied from the coating liquid source, to the base material; a valve provided between the discharge unit and the coating liquid source; a linear motor that opens and closes the valve; an acquisition unit that acquires information on the time from the start of valve closing operation of the valve to the end thereof; a linear motor control unit that drives the linear motor drive so that the valve is closed at the acquired time; and a measurement unit that measures the pressure within the discharge unit.

### BRIEF DESCRIPTION OF THE DRAWINGS

FIG. 1 is a view illustrating the configuration of a coating apparatus related to an embodiment.

FIG. 2 is a view illustrating the pressure within a discharge unit output by the output unit.

FIG. 3 is a flow chart illustrating an example of adjustment processing in the coating apparatus.

FIG. 4A illustrates a pressure fluctuation in a first liquid passage in a case where the pressure after valve closing is higher than a threshold value, and FIG. 4B is a view illustrating a coating state in that case.

FIG. 5A illustrates a pressure fluctuation in the first liquid passage in a case where the pressure after the valve closing is lower, and FIG. 5B is a view illustrating a coating state in that case.

FIG. 6 is a view illustrating the configuration of a coating apparatus related to another embodiment.

FIG. 7 is a flow chart illustrating an example of adjustment processing in the coating apparatus.

### DETAILED DESCRIPTION

It is desirable that the coating region ideally have a constant height (thickness), and the cross-sectional shape thereof be a substantially oblong shape. For example, in order to form the vicinity of an ending point of the coating region in an edge shape, generally, it is necessary to increase the speed of the valve closing operation of the valve. However, the present inventor has recognized that, if the valve closing operation of the valve is performed at a high speed, the liquid pressure within the coating apparatus significantly changes, and a so-called double-coating phenomenon in which a coating liquid is instantaneously discharged immediately after the end of coating occurs depending on the case.

There is a need for a coating apparatus that can suppress occurrence of double coating while maintaining the shape of a relatively excellent coating region.

According to this aspect, the information on the time from the start of the valve closing operation of the valve to the end thereof and the pressure within a discharge unit can be matched with each other and grasped.

In addition, arbitrary combinations of the above constituent elements, and those obtained by substituting the constituent elements or expressions of the invention with each other between apparatuses, methods, systems, or the like are also effective as the aspects of the invention.

According to the invention, it is possible to suppress occurrence of double coating while maintaining the shape of a relatively excellent coating region.

Hereinafter, the same or equivalent constituent elements, members, and processes illustrated in respective drawings will be designated by the same reference numerals, and duplicate description will be appropriately omitted. Additionally, the dimensions of the members in the respective drawings are appropriately illustrated in an enlarged or reduced manner in order to make the invention easily understood. Additionally, when an embodiment is described in the respective drawings, some members that are not important will be omitted.

### One Embodiment

The outline of a coating apparatus related to the present embodiment is as follows. The coating apparatus related to the present embodiment intermittently coats a coating liquid on abase material to thereby form a coating pattern alternately having a coating region and a non-coating region on the base material. Here, it is desirable that the coating region ideally have a constant height (thickness), and the cross-sectional shape thereof be a substantially oblong shape. For example, in order to form the vicinity of an ending point of the coating region in an edge shape, generally, it is necessary to increase the speed of the valve closing operation of a valve. However, the present inventor has obtained, from various experiments conducted by the inventor, the knowledge that, if the valve closing operation of the valve is performed at a high speed, the liquid pressure within a discharge unit of the coating apparatus significantly changes immediately after the valve closing of the valve, and the so-called double-coating phenomenon occurs depending on the case. Therefore, the present inventor has recognized that it is necessary to adjust the speed of the valve closing operation of the valve so that occurrence of the double coating can be suppressed, while maintaining a relatively excellent coating region (namely, a coating region whose cross-sectional shape is a substantially oblong shape) as advance preparations of coating work.

In contrast, the coating apparatus related to the present embodiment includes an acquisition unit that acquires information on the time from the start of the valve closing operation of the valve to the end thereof, and a measurement unit that measures the pressure within the discharge unit. Therefore, the information on the speed of the valve closing operation of the valve and the pressure within the discharge unit can be grasped after being matched with each other, and it is possible to adjust the speed of the valve closing operation so that the double coating does not occur. Hereinafter, specific description will be given.

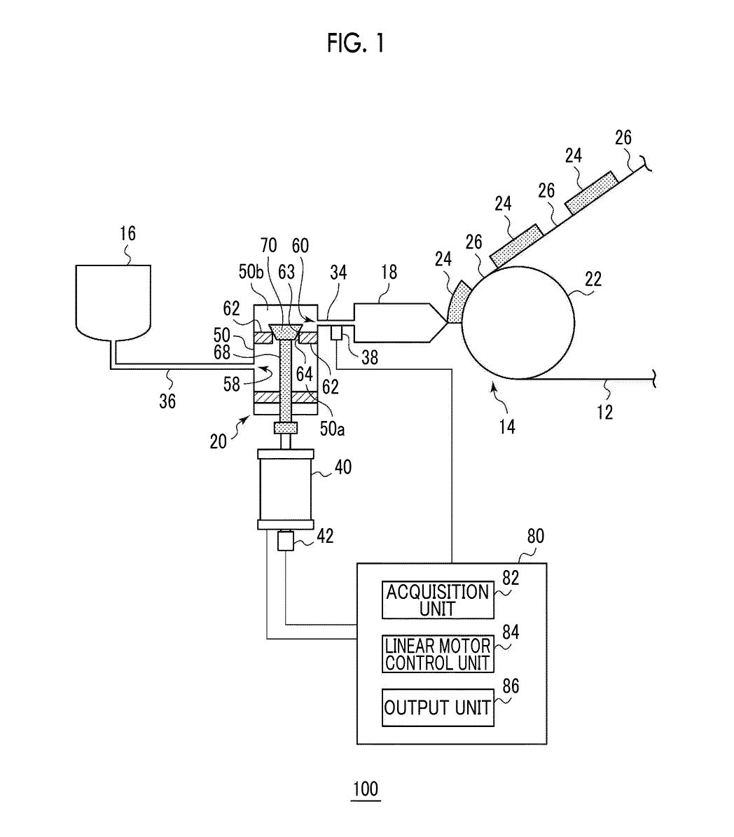

FIG. 1 illustrates the configuration of a coating apparatus 100 related to the present embodiment. The coating apparatus 100 is used for the formation of an electrode member of a lithium ion battery. The coating apparatus 100 coats a solvent having lithium cobaltate oxidization cobalt as main constituents on the surface of a sheet made of aluminum foil, when a positive electrode member is formed. When a negative electrode member is formed, a solvent having carbon as a main constituent is coated on the surface of a sheet made of copper foil.

The coating apparatus 100 includes a conveying device 14, a tank 16, a die 18, a valve 20, a first liquid passage 34, a second liquid passage 36, a measurement unit 38, a linear motor 40, an encoder 42, and a controller 80.

The conveying device 14 includes a plurality of conveying rollers that is rotationally driven by a motor (not illustrated) or the like, and conveys an elongated sheet 12 made of a metallic thin film in a longitudinal direction thereof. The conveying device 14 basically conveys the sheet 12 at a regular speed. In FIG. 1, a main roller 22 is disposed so that a coating position of the sheet 12 to be conveyed is supported from a back side. The die 18 is arranged so as to face the main roller 22 at the coating position.

The die 18 has a slit that is arranged to face a coating surface of the sheet 12. A coating liquid is supplied to the die 18 via a first liquid passage 34, and the coating liquid is intermittently discharged to the sheet 12 in a conveyance state from the slit. That is, the first liquid passage 34 and the die 18 function as a discharge unit that discharges the coating liquid to the sheet 12.

The tank 16 stores the coating liquid including the above-described solvent. A pump (not illustrated) is between the tank 16 and the valve 20, and accordingly, the coating liquid is delivered to the valve 20 at a substantially constant pressure from the tank 16.

The valve 20 is an electromagnetic valve that is driven by the linear motor 40. The valve 20 changes the flow rate of the coating liquid to be supplied from the tank 16 to the die 18. As described above, since the liquid pressure on the upstream side is substantially constant, the discharge flow rate of the coating liquid to be discharged from the slit of the die 18 is approximately proportional to the opening degree of the valve 20.

The valve 20 includes a tubular body 50 that has a coating liquid flow passage formed therein, and an operating rod 68 that extends with a central axis of the tubular body 50 as a center. A partition wall 62 that partitions the interior of the body 50 into an upstream portion 50a and a downstream portion 50b is provided inside the body 50. A valve hole 64 that constitutes a valve unit is provided at the center of the partition wall 62. An introduction port 58 for introducing the coating liquid from the tank 16 to the upstream portion 50a, and a delivery port 60 for delivering the coating liquid from the downstream portion 50b to the die 18 are provided at a lateral portion of the body 50.

A valve body 70 is integrally provided at the end of the operating rod 68 on the downstream portion 50b side. The valve body 70 is attached or detached with respect to the valve hole 64 from the delivery port 60 side to open and close the valve unit. That is, a valve seat 63 is formed by a downstream opening end edge of the valve hole 64 in the partition wall 62, and a tapered surface of the valve body 70 is detached to and attached from the valve seat to thereby open and close the valve unit.

The linear motor 40 is configured so that the direction of thrust is determined depending on the direction of an electric current to be applied and the magnitude of thrust is determined depending on the magnitude of the electric current to be applied. The thrust generated by the linear motor 40 is transmitted to the valve body 70 via the operating rod 68 so as to adjust the opening degree of the valve unit. Namely, the valve opening degree of the valve 20 is adjusted depending on an energization state where an electric current is supplied to the linear motor 40.

The encoder 42 detects the movement distance of the valve body 70 from the movement distance of a movable element of the linear motor 40. The encoder 42 passes the detected movement distance to an output unit 86. The measurement unit 38 measures the pressure of the coating liquid within the first liquid passage 34. The measurement unit 38 passes the measured pressure to the output unit 86. In addition, the measurement unit 38 may measure the pressure within the die 18.

The controller 80 includes a CPU that executes various kinds of computation processing, a ROM that stores various control programs, a RAM that is used as a work area for data storage or program execution, an input/output interface, a backup memory, and the like. The controller 80 adjusts an electric current to be supplied to the linear motor 40 to control the valve opening degree. The controller 80 controls the discharge amount of the coating liquid so that a preset coating pattern is formed on the sheet 12. The coating liquid is intermittently discharged from the die 18 by the control of the controller 80. As a result, a predetermined coating pattern alternately having a coating region 24 and a non-coating region 26 is formed on the surface of the sheet 12.

The controller 80 includes an acquisition unit 82, a linear motor control unit 84, and the output unit 86. The acquisition unit 82 acquires a target position and a target time (hereinafter referred to as “valve closing operation time”) that are input by a user and are required from the start of the valve closing operation of the valve 20 to the end thereof. The acquisition unit 82 may acquire a target time that is required from the start of the valve opening operation of the valve 20 to the end thereof, a time during which the valve 20 is open, a time during which the valve 20 is closed, or the like.

The linear motor control unit 84 supplies an electric current to the linear motor 40, and makes the valve 20 open and close with the thrust thereof. Particularly, the linear motor control unit 84 controls the linear motor 40 so that the valve 20 is closed at a target time acquired by the acquisition unit 82. That is, the magnitude of the current to be supplied to the linear motor 40 is adjusted so that a valve 20 is closed at a target position and the target time that are acquired by the acquisition unit 82.

The output unit 86 outputs the pressure within the first liquid passage 34 measured by the measurement unit 38 in an aspect in which the pressure can be visually recognized. Particularly, the output unit 86 outputs the pressure within the first liquid passage 34 until a predetermined period after the valve 20 is closed. Additionally, the output unit 86 matches the pressure within the first liquid passage 34 with the information (for example, the movement distance of the valve body 70) showing the open/closed state of the valve 20, and outputs the results. The output unit 86 outputs the results to a display instrument, such as a display. In addition, the output unit 86 may output the results to a printing apparatus, such as a printer.

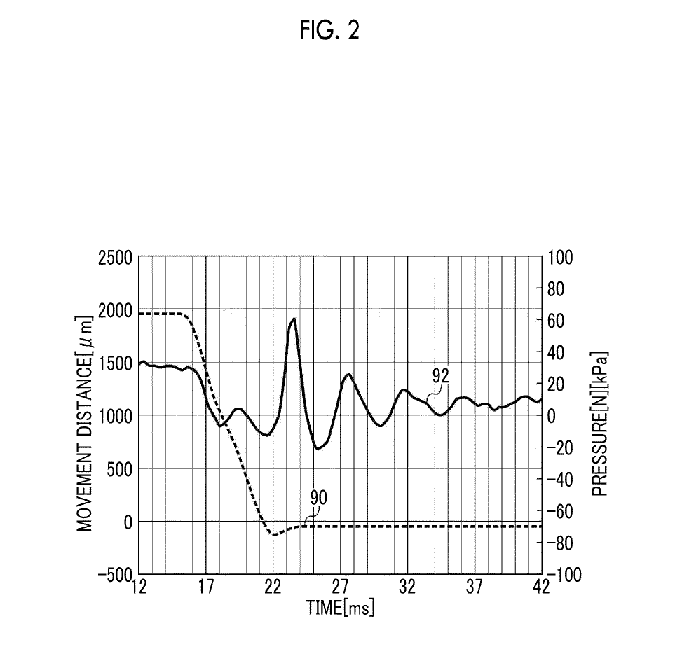

FIG. 2 is a graph illustrating an example of a pressure fluctuation within the first liquid passage 34. FIG. 2 illustrates the pressure within the first liquid passage 34 and the opening degree of the valve 20, which are output by the output unit 86. In FIG. 2, the horizontal axis represents time. The left-hand vertical axis represents the degree of opening and closing of the valve 20 (the movement distance of the valve body 70), and represents a state where the valve 20 is closed in the case of 0 μm. As illustrated by Graph 90, the valve 20 moves 2000 μm at 6 ms, and is closed. The right-hand vertical axis represents the pressure within the first liquid passage 34. As illustrated by Graph 92, the pressure fluctuates sharply immediately after the valve 20 is closed.

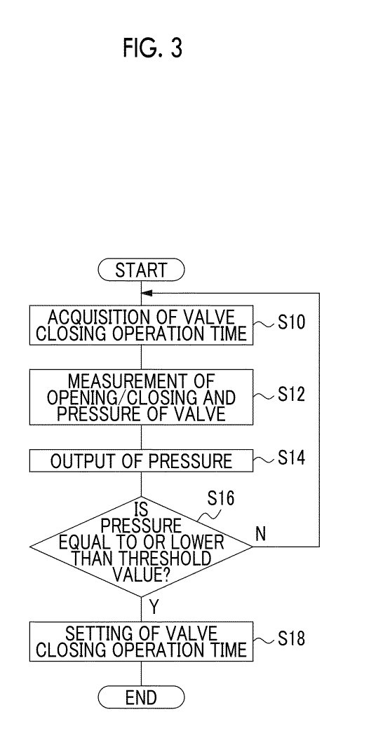

The operation of the coating apparatus 100 configured as above will be described. FIG. 3 is a flowchart illustrating an example of adjustment processing in the coating apparatus 100. The acquisition unit 82 acquires the valve closing operation time of the valve 20 (S10). The linear motor control unit 84 supplies an electric current to the linear motor 40 to make the valve 20 open and closed. Particularly, the linear motor control unit 84 performs the valve closing of the valve 20 at the valve closing operation time acquired by the acquisition unit 82. The measurement unit 38 measures the pressure within the first liquid passage 34 in this case (S12). The output unit 86 outputs the pressure within the first liquid passage 34 to the display instrument (S14). A user determines whether or not the pressure after the valve closing is higher than a predetermined threshold value by referring to this output (S16). That is, since the speed of the valve closing operation is too high, it is determined whether or not the double coating may occur. When the pressure is higher than the threshold value (N of S16), the user inputs a longer valve closing operation time, and the processing returns to S10. When the pressure is equal to or lower than the threshold value (Y of S16), the valve closing operation time acquired by the acquisition unit 82 is determined as an optimum value. That is, the valve closing operation time when the pressure of the first liquid passage 34 becomes equal to lower than the threshold value for the first time while the valve closing operation time is lengthened little by little is determined as an optimum valve closing operation time (S20). The coating apparatus 100 carries out coating work at the valve closing operation time that is determined in this way.

According to the coating apparatus 100 related to the present embodiment, the pressure within the first liquid passage 34 in a predetermined period is output in an aspect in which the pressure can be visually recognized after the valve 20 is closed. Accordingly, the user can determine whether or not it is necessary to lengthen the valve closing operation time in order to suppress occurrence of the double coating.

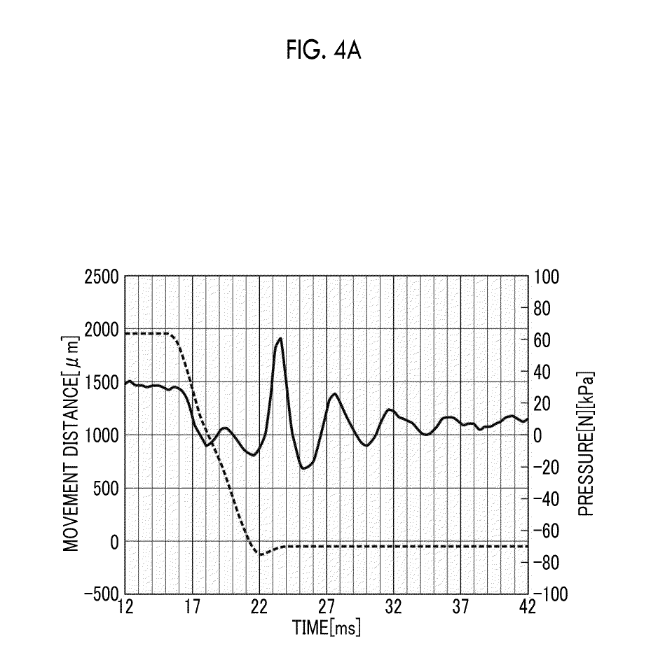

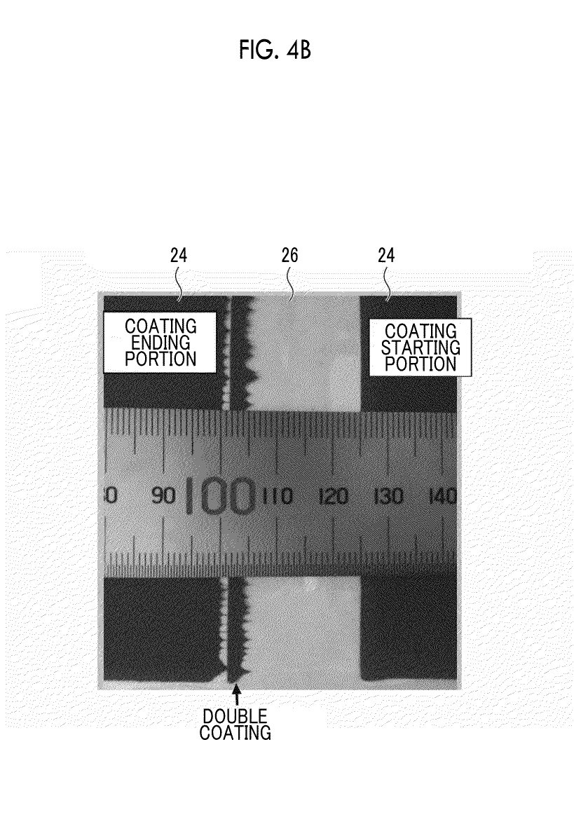

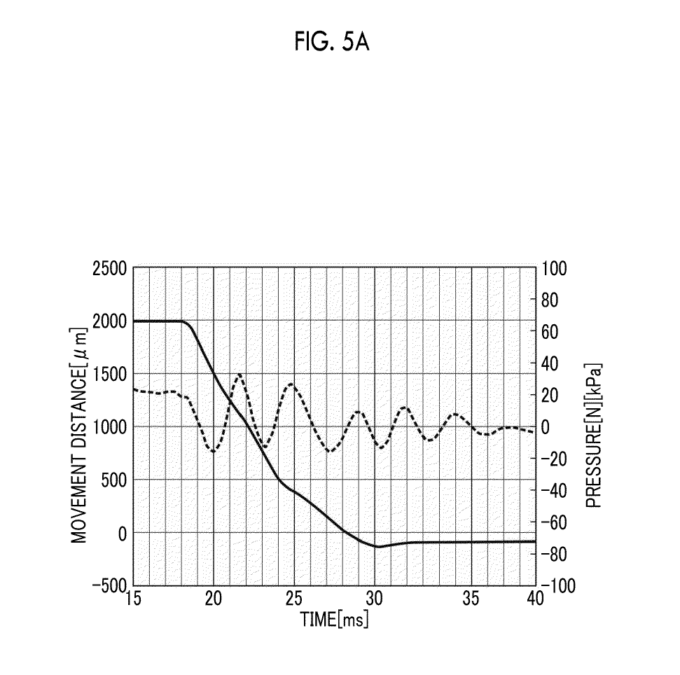

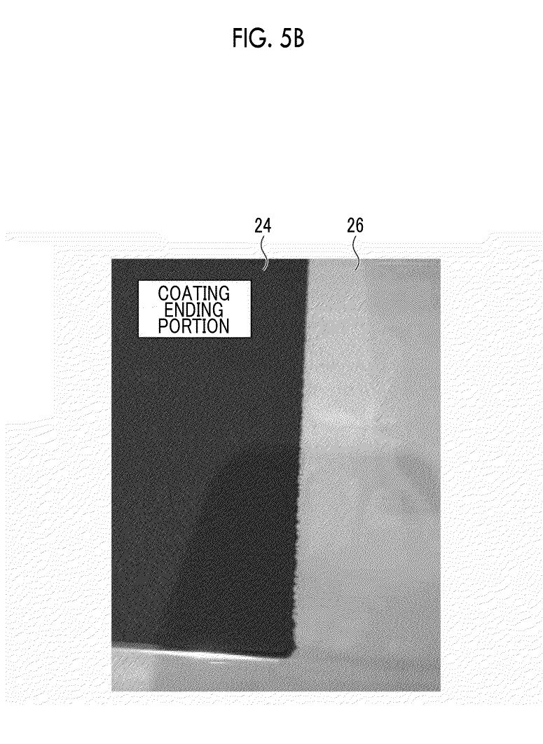

The present inventor has experimented in order to confirm a double coating suppressing effect. FIG. 4A illustrates a pressure fluctuation in the first liquid passage 34 in a case where the pressure after valve closing is higher than a threshold value, and FIG. 4B is a view illustrating a coating state in that case. FIG. 5A illustrates a pressure fluctuation in the first liquid passage 34 in a case where the pressure after valve closing is lower than the threshold value, and FIG. 4B is a view illustrating a coating state in that case . In addition, in the present experiment, the pressure within the first liquid passage 34 at the time of discharge was used as the threshold value. As illustrated in FIGS. 4A and 4B, when the pressure after the valve closing is higher than the threshold value, the so-called double coating occurs. In contrast, as illustrated in FIGS. 5A and 5B, when the pressure after the valve closing is equal to lower than the threshold value, the double coating does not occur. Additionally, the shape of a coating ending portion also has an aesthetic shape compared to that in FIGS. 4A and 4B.

### Another Embodiment

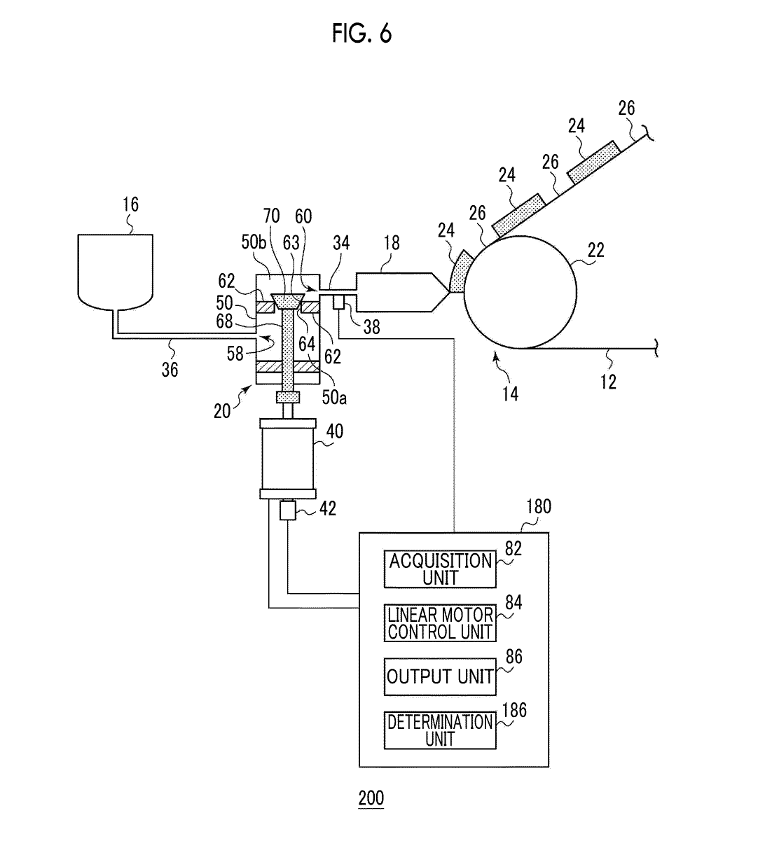

FIG. 6 illustrates the configuration of a coating apparatus 200 related to another embodiment. The coating apparatus 200 includes a conveying device 14, a tank 16, a die 18, a valve 20, a first liquid passage 34, a second liquid passage 36, a measurement unit 38, a linear motor 40, an encoder 42, a driver 44, and a controller 180. In the present embodiment, the measurement unit 38 also passes a measurement result to a determination unit 188 (to be described below) in addition to the output unit 86. Similarly, the encoder 42 also passes a detection result to the determination unit 188 in addition to the output unit 86.

The controller 180 includes the acquisition unit 82, the linear motor control unit 84, the output unit 86, and the determination unit 188. The acquisition unit 82 acquires the valve closing operation time input by the user or the valve closing operation time passed from the determination unit 188.

The determination unit 188 determines whether or not the pressure within the first liquid passage 34 acquired by the measurement unit 38 is equal to or lower than a predetermined threshold value. Particularly, the determination unit 188 determines whether or not the pressure until the predetermined period after the valve closing is equal to or lower than the threshold value. The determination unit 188 passes a valve closing operation time longer than the valve closing operation time, which has been previously acquired by the acquisition unit 82, to the acquisition unit 82 as a new valve closing operation time when the pressure within the first liquid passage 34 is higher than the threshold value. For example, the determination unit 188 passes to the acquisition unit 82 a time obtained by adding a predetermined time (for example, 1 ms) to a previous valve closing operation time, as the new valve closing operation time.

The operation of the coating apparatus 200 configured as above will be described.

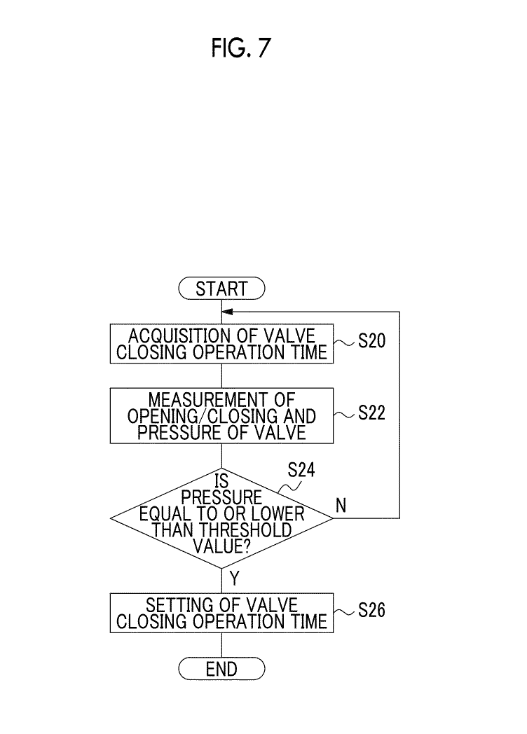

FIG. 7 is a flowchart illustrating an example of adjustment processing in the coating apparatus 200. The acquisition unit 82 acquires the closing operation time of the valve 20 (S20). The linear motor control unit 84 supplies an electric current to the linear motor 40 to make the valve 20 open and closed. Particularly, the linear motor control unit 84 performs the valve closing of the valve 20 at the valve closing operation time acquired by the acquisition unit 82. The measurement unit 38 measures the pressure within the first liquid passage 34 in this case (S22). The determination unit 188 determines whether or not the pressure within the first liquid passage 34 is equal to or lower than a predetermined threshold value (S24). When the pressure is higher than the threshold value (N of S24), the determination unit 188 passes a valve closing operation time longer than a previous valve closing operation time to the acquisition unit 82, and the processing is returned to S20. When the pressure is equal to or lower than the threshold value (Y of S24), a target time acquired by the acquisition unit 82 is determined as an optimum value (S26).

According to the coating apparatus 200 related to the present embodiment, the same effects as the effects exhibited by the coating apparatus 100 related to the present embodiment are exhibited. In addition, according to the coating apparatus 200 related to the present embodiment, since the valve closing operation time is automatically adjusted, a user's burden is alleviated.

The configuration and operation of the coating apparatus related to the embodiments has been described above. It will be understood by those skilled in the art that these embodiments are merely illustrative, various modification examples are possible by the combinations of the respective constituent elements, and such modification examples are also within the scope of the invention.

Although a case where the acquisition unit 82 acquires the target time required from the start of the opening and closing operation of the valve 20 to the end thereof has been described in the embodiments, the invention is not limited to this. For example, the acquisition unit 82 may acquire the speed of the opening and closing operation of the valve 20, the linear motor control unit 84 may give the speed of the opening and closing operation to the linear motor 40, and the linear motor 40 may open and close the valve at the given speed.

It should be understood that the invention is not limited to the above-described embodiments, but may be modified into various forms on the basis of the spirit of the invention. Additionally, the modifications are included in the scope of the invention.

What is claimed is:

1. A coating apparatus that intermittently coats a coating liquid on a base material that travels in a predetermined direction, the coating apparatus comprising:
a coating liquid source that stores coating liquid;
a discharge unit that discharges the coating liquid, which is supplied from the coating liquid source, to the base material;
a valve provided between the discharge unit and the coating liquid source;
a linear motor that opens and closes the valve;
an acquisition unit that acquires information on the time from the start of valve closing operation of the valve to the end thereof;
a linear motor control unit that drives the linear motor drive so that the valve is closed at the acquired time; and
a measurement unit that measures the pressure within the discharge unit.

2. The coating apparatus according to claim 1, further comprising:
a determination unit that determines whether a pressure within the discharge unit until a predetermined period after the valve is closed is equal to or lower than a threshold value.

3. The coating apparatus according to claim 2,
wherein the linear motor control unit drives the linear motor so that the valve is closed at a first time,
the determination unit determines whether or not the pressure within the discharge unit until the predetermined period after the valve is closed at the first time is equal to or lower than the threshold value, and
wherein when the pressure within the discharge unit is higher than the threshold value as a result of the determination performed by the determination unit, the linear motor control unit drives the linear motor so that the valve is closed at a second time longer than the first time.

4. The coating apparatus according to claim 2,
wherein the threshold value is approximately equal to the pressure within the discharge unit when the coating liquid is discharged.

5. The coating apparatus according to claim 1, further comprising:
an output unit that outputs the pressure within the discharge unit until a predetermined period after the valve is closed, in an aspect in which the pressure can be visually recognized.

6. The coating apparatus according to claim 1, further comprising:
an output unit that outputs the pressure within the discharge unit in a recognizable aspect,
wherein the output unit matching the pressure within the discharge unit with information showing the open/closed state of the valve, and outputting the results.
